(19) United States
(12) Patent Application Publication
(10) Pub. No.: US 2002/0059105 A1
(43) Pub. Date: May 16, 2002

(54) Method and apparatus for managing purchase points

(75) Inventors: Atsushi Maeda, Osaka (JP); Takashi Hazui, Aichi (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,237

(22) Filed: Mar. 30, 2001

(30) Foreign Application Priority Data
Sep. 22, 2000 (JP) 2000-288060

(51) Int. Cl. G06F 17/60

(52) U.S. Cl. 705/26; 709/217

(57) ABSTRACT

A purchase point managing apparatus is built in an online shopping site, and is communicated with the users via the Internet. Points the users earned by purchasing merchandise are recorded in a point table. A merchandise recommending unit selects and recommends to the user the candidates of merchandise to be purchased by calculating a point short of in order to acquire a prize whose rank is higher than one. The purchase point managing apparatus includes a point transfer unit in which the points are transferred between the users, and a history notifying unit which offers to the user a function of the housekeeping account book.

### BACKGROUND OF THE INVENTION

1. Field of the Invention

The present invention relates to a purchase point managing technique, and it particularly relates to method and apparatus for managing purchase points given at the time a user purchases merchandise or the like via on-line or offline.

2. Description of the Related Art

Conventionally, a sales promotion is known in which a purchase point is given to a shopper (referred to as a user hereinafter) and will be accumulated every time he/she buys merchandise or a service. For example, airlines carry out not only their own airline services but also other services in which the point the user earned through restaurant use and hotel staying is exchanged for mileage to be accumulated. The user can redeem the earned mileage for an air ticket and the like when he/she earns predetermined miles. Though not large-scale as the mileage service, the point service has been made use of for purchase of, for example, a record, CD or music tapes and the like, at each shop or in its affiliated one's network.

Recently, accompanied by a rapid expansion of online shopping utilizing the WWW (World Wide Web) of the Internet, the point service tends to expand as well. Since the online shopping does not depend on where to operate, it can attract users who reside remotely from a shop site, namely, it could attract anyone connected to the Internet. However, there exists a danger where users who reside closely to the site may be captured by competitors. Moreover, since the user can compare prices of merchandise at home, the shops must endeavor not only to win the price competition but also secure returning users by providing value-added services. As a means therefor, the point service needs to be restructured and effectively utilized.

However, since there are an incredibly large number of online shopping sites available and they develop each own point servicing, the users have hard time in figuring out which company and which point scheme their purchase activities are linked to. For example, many users experience a case where though a purchase of merchandise at one shop is linked to a discount at other shops, the users are not aware of it and they miss out on the discounted service then. Moreover, though the user has saved up certain eligible points, he/she could not understand as to which prize is to be exchanged for the points, so that he/she might have used the points in an incomplete and unwise manner to his/her regret.

### SUMMARY OF THE INVENTION

The present invention has been made in view of the foregoing drawbacks, and an object thereof is to provide a support technique so that users can make most effective use of the purchase points.

An aspect of the present invention relates to a purchase point managing apparatus. The apparatus includes a point table, a merchandise table and an exchange table. The point table records per user a total value of points which a user earns by purchasing merchandise. The merchandise table which describes relationship between the merchandise and a point earned as a result of purchase thereof. The exchange table which describes relationship between the point and a prize offered to the user according to the point earned. Usually, a prize will be given by exchanging the earned points for it. The apparatus further includes a merchandise recommending unit which presents to the user a merchandise candidate to be purchased so as to acquire a predetermined prize.

By implementing this structure, when the user purchases merchandise, points corresponding to the merchandise is determined based on the merchandise table so as to be recorded in the point table. If the user already has some points, total points of the already earned points and points earned this time will be recorded. Thereafter, the exchange table will be referred to at some stage, and a prize exchangeable for the user's earned points will be determined. However, there are many cases where a rank of the exchangeable prize can be upgraded if a few more points are added by purchasing a bit more. A preferred embodiment according to the present invention pays attention to this point, so that the merchandise recommending unit detects a possible prize obtainable with certain additional purchase and then presents a candidate of merchandise to be purchased. Thus, the user can realize an optimum usage of the points while purchasing necessary merchandise.

Information on said candidate may be stored in a candidate table. In that case, the candidate table may store, in addition to said candidate table, information on a plurality of merchandise candidates in combination to be purchased by which to acquire the predetermined prize. In order to obtain additional points (shortage points) to reach total points (target points) necessary for acquiring a higher-ranked prize, the user needs to purchase merchandise. Then, it will be easier for the user to make a plan if the shortage points can be filled in by purchasing a plurality of merchandise in combination. Thus, such candidates are shown by combination of the merchandise.

The merchandise recommending unit may combine the merchandise to be purchased and a purchasing timing thereof by referring to the merchandise table so as to define a purchasing model, and present the purchasing model to the user. A point system usually sets a validity date for the points earned during a certain period. Thus, for example, if a condition such as in “purchase until November this year” is indicated to the user, the user needs not to worry so much about the validity date of the earned points.

The purchase point managing apparatus may further include a user data table which stores individual data on the user, wherein said merchandise recommending unit may present to the user a purchasing model suitable for the user by extracting the purchasing model from the candidate table based on the individual data. For example, for the user who is found to be a wine lover based on the questionnaire or purchase history in the past, there is a way in which wine would be recommended to this particular user.

The apparatus may further include a point transfer unit. The point transfer unit transfers points in whole or in part earned by the user to another user, or transfers points earned by a single user between points earned under other point managing system and those earned in the purchase point managing apparatus. The “point managing system” means a system in which the point system is managed and operated by a certain shop independently, or in cooperation with a plurality of shops. The point transfer unit may present, in a user selectable manner, to the user other point managing system to and from which a point is transferable.

The apparatus may further include a history notifying unit. The history notifying unit manages a purchase history of the user in the past and classifies merchandise purchased by the user based on a predetermined criterion so as to be presented to the user. The classifying procedure is performed based on criteria used in the household accounts such as counting items, a period such as “for the past 6 months”, a scheduled user such as “for myself”, “for family members” and “for the company”, and a purchase amount such as “5000 yen or more”.

The apparatus may further include a prize presenting unit. The prize presenting unit presents the prize exchanged for the points, via on-line or off-line. Prior to this presentation, the prize presenting unit indicates in advance a single prize or a plurality of prizes in combination exchangeable for the points. Suppose that the user has 1000 points. The user tries to make out a best possible use of the points by not wasting any within the 1000 points. Such a best possible combination is indicated by the prize presenting unit, so that the user can make up his/her mind easily and quickly.

Another aspect of the present invention relates to a method of managing a purchase point. The method includes: recording per user a total value of points which a user earns by purchasing merchandise; selecting a merchandise candidate which is recommended to purchased in order to acquire a predetermined prize, by comparing relationship between the merchandise, a point earned as a result of purchase of the merchandise and a prize offered to the user according to the point earned, to the total value of points; and presenting the merchandise candidate selected to the user. Moreover, the user may specify his/her desired prize as the predetermined prize, in which case candidates of merchandise necessary for filling in the shortage points to obtain the prize is indicated.

Moreover, any arbitrary combination of the abovementioned structural components in the present invention is still effective as an embodiment of the present invention when applied as apparatus, a method, a system, a recording medium and so forth.

Moreover, this summary of the invention does not necessarily describe all necessarily features so that the invention may also be sub-combination of these described features.

### BRIEF DESCRIPTION OF THE DRAWINGS

FIG. 1 shows an overall structure of a network system 10 including a purchase point managing apparatus 24 according to an embodiment of the present invention.

FIG. 2 shows an internal structure of a purchase point managing apparatus 24.

FIG. 3 shows an internal structure of a merchandise table T2.

FIG. 4 shows an internal structure of an exchange table T5.

FIG. 5 shows an internal structure of a point table T4.

FIG. 6 shows an internal structure of a purchase history table T1.

FIG. 7 shows an internal structure of a user data table T3.

FIG. 8 shows an internal structure of a candidate table T6.

FIG. 9 is an example of a screen 120 displayed on the user terminal 12 when the user accesses an on-line shopping page in the purchase point managing site 16.

FIG. 10 is a screen 120 displayed on a user terminal 12 when a user clicks on a “your point” button 128.

FIG. 11 is a screen 120 displayed on the user terminal 12 when a user “Taro” clicks on a “hint for purchase” button 146.

FIG. 12 is a screen 120 displayed on the user terminal 12 when the user clicks on the “point transfer” button 148 on the screen 120 shown in FIG. 10.

FIG. 13 is a screen 120 displayed on the user terminal 12 when the user clicks on a link 184.

FIG. 14 is a screen 120 displayed on the user terminal 12 when the user clicks on the housekeeping account book button 150 shown in FIG. 10.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

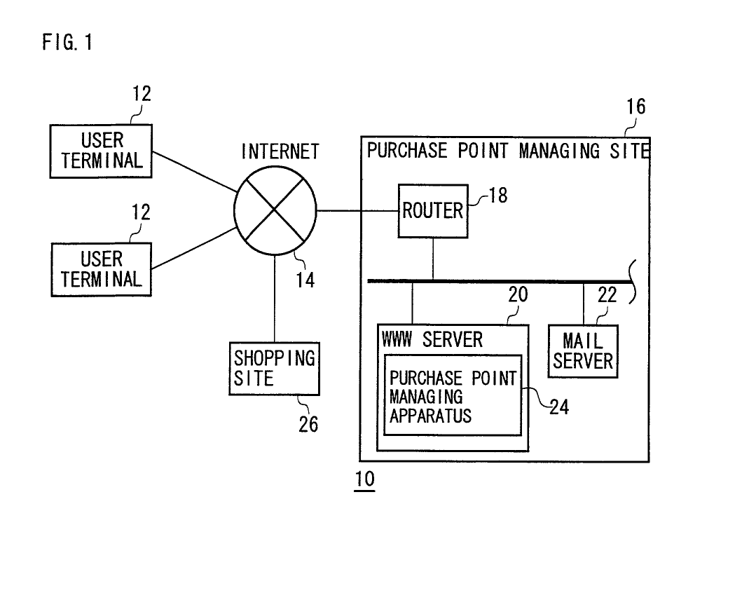

FIG. 1 shows an overall structure of a network system 10 including a purchase point managing apparatus 24 according to an embodiment of the present invention. Here, a user terminal 12 and a purchase point managing site 16 are connected via the Internet 14. The user terminal 12 includes a personal computer (PC), a personal digital assistant (PDA), a mobile phone which can be connected to the Internet 14, and other arbitrary hardware. The purchase point managing site 16 is a usual site, but it may also function as an Internet Service Provider (ISP) for the user terminal 12. Moreover, in general it may serve as a portal site for sorting and managing information so as to meet the convenience of users. In what is to follow, the user utilizes the purchase point managing site 16 as a portal site having an on-line shopping capability.

The purchase point managing site 16 includes a WWW server 20 which exchanges information with the Internet 14 via a router 18, a mail server 22, a DNS server (not shown) and so forth. Though a purchase point managing apparatus 24 is provided inside the WWW server 20, the apparatus 24 may be provided as an independent server and can be realized by other various modes.

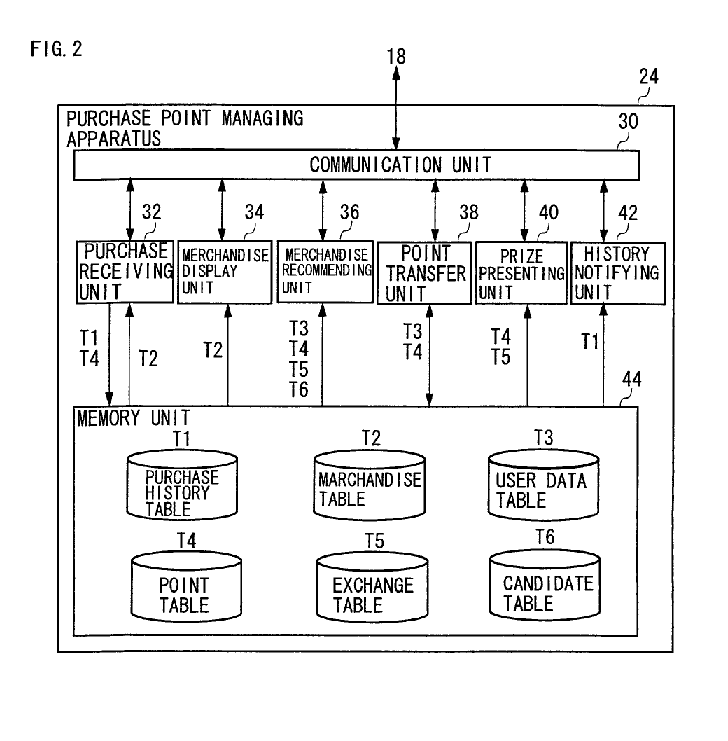

FIG. 2 shows an internal structure of the purchase point managing apparatus 24. In terms of hardware components, the structure can be realized by a CPU, a memory and other LSI functions of the WWW server 20 while in terms of software it can be realized by a program, loaded in the memory of the WWW server 20, capable of performing purchase point related functions, or the like. However, FIG. 2 is a functional block realized by those in combination. Thus, it is to be understood by those skilled in the art that the functional block is realizable by hardware alone, software alone or those in combination or other various modes.

Each processing unit of the purchase point managing apparatus 24 communicates with the user terminal 12 via a communication unit 30. A memory unit 44 includes a purchase history table T1, a merchandise table T2, user data table T3, a point table T4, an exchange table T5 and a candidate table T6. The details of each table will be described later, and the brief description therefor is given here. The purchase history table T1 records, per user, merchandise purchased at the purchase point managing site 16. The merchandise table T2 stores data on merchandise and a point given when the merchandise is purchased. The user data table T3 records user's individual data. The point table T4 records, per user, the total points the user has earned. The exchange table T5 shows a relation between the earned points and a prize exchangeable therefor. The candidate table T6 stores data on candidates of merchandise which is possible to fill in the points short of in order to win a prize whose level is higher by one rank.

The merchandise display unit 34 reads out merchandise data from the merchandise table T2, and displays the read-out merchandise data on a screen of the user terminal 12. A purchase receiving unit 32 receives from the user the purchase of merchandise through the on-line shopping. When the user decides to purchase certain merchandise, the purchase receiving unit 32 refers to the merchandise table T2 and specifies a point to be given to the user, so that the total values of the points earned by the user is updated at the point table T4. Moreover, the purchase receiving unit 32 adds said merchandise to a purchase history of the user at the purchase history table T1.

A merchandise recommending unit 36 presents a candidate of merchandise to a user when he/she inquires about status of his/her point. When the candidate is purchased, the user's point increases and acquires a prize whose rank is higher by one. Thus, the current point of the user who inquired is read out of the point table T4, and a target point by which to reach at the one-rank higher prize is specified from the exchange table T5. Next, the current point is subtracted from the target point so as to calculate a point short of. Thereafter, merchandise by which to compensate for the shortage point is selected from the candidate table T6 so as to be presented to the user. Then, the user data table T3 is referred to in order to introduce merchandise which the user most probably prefers.

A point transfer unit 38 has two functions. The first function relates to a processing in which a user exchanges his/her points with other users who utilize the purchase point managing site 16. The second function relates to a processing in which a point earned by the user at other point systems, for example, at other on-line or off-line shopping sites, is added up to the point earned at the purchase point managing site 16, or, conversely, the point earned at the site 16 is transferred to somewhere else. When the point is transferred, the point table T4 is updated. In a case where a special approval between users is required for the transfer, the user data table T3 is referred to.

When the user requests an exchange of the point for a prize, a prize presenting unit 40 specifies a point to be exchanged by using the exchange table T5, so that the point table T4 is updated by subtracting the specified point from the user's point. Arrangement for and delivery of the prize may be processed by a back end.

When the user inquires about his/her own purchase history, a history notifying unit 42 refers to the purchase history table T1 and classifies the merchandise purchased by the user in the past according to a predetermined criterion so as to be presented to the user.

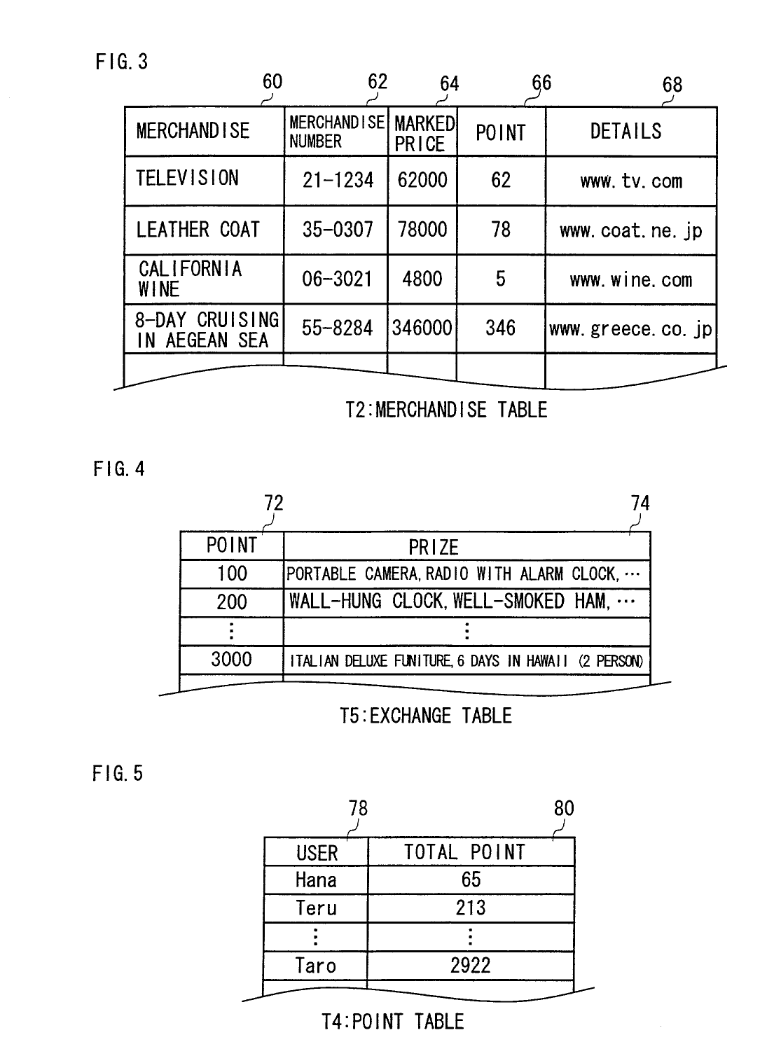

FIG. 3 shows an internal structure of the merchandise table T2. The merchandise table T2 includes a merchandise column 60, a merchandise number column 62, a marked price column 64, a point column 66 and a details column 68. For example, a television is the merchandise in question; described are “21-1234” as merchandise number, “62000 yen” as the marked price, “62” as points given to purchase thereof, and the URL www.tv.com as a page showing the detail information of the merchandise. In this example, one point corresponds to 1000 yen (a fraction being raised). The merchandise is not limited to goods but may include a trip such as “eight-day cruising in the Aegean Sea” and other services. When the user accesses a page for on-line shopping, the merchandise display unit 34 reads out data from the merchandise table T2 and displays also an image (not shown) if necessary.

FIG. 4 shows an internal structure of the exchange table T5. The exchange table T5 includes a point column 72 and a merchandise column 74, and describes therein that, for example, the points earned are exchangeable for “a portable camera, a radio with alarm clock, etc.” when the earned points accumulate to 100 points. Here, a single point is exchanged for and worth about 50 yen. Thus, the user gets 50 yen back against a purchase of 1000 yen, and its rate is 5%.

FIG. 5 shows an internal structure of the point table T4. The point table T4 includes a user column 78 and a total point column 80. For example, the points earned by users “Hana” and “Taro” are “65” points and “2922” points, respectively.

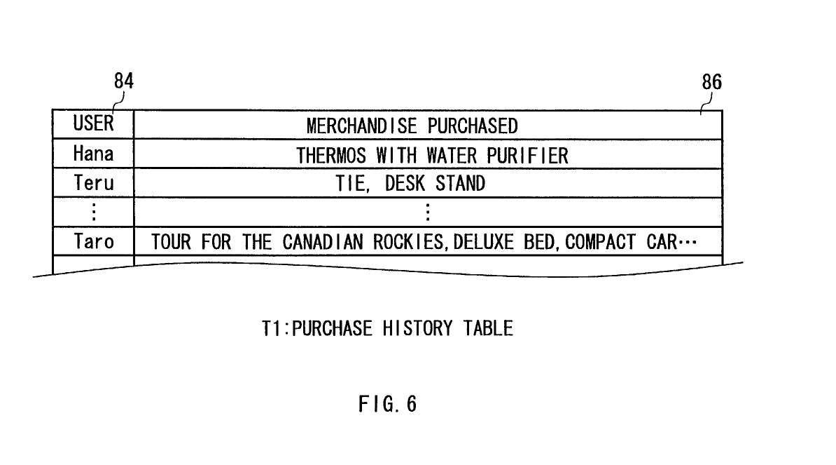

FIG. 6 shows an internal structure of the purchase history table T1. The purchase history table T1 includes a user column 84 and a purchased-merchandise column 86. For example, “a thermos with water purifier” is described therein as the merchandise purchased in the past.

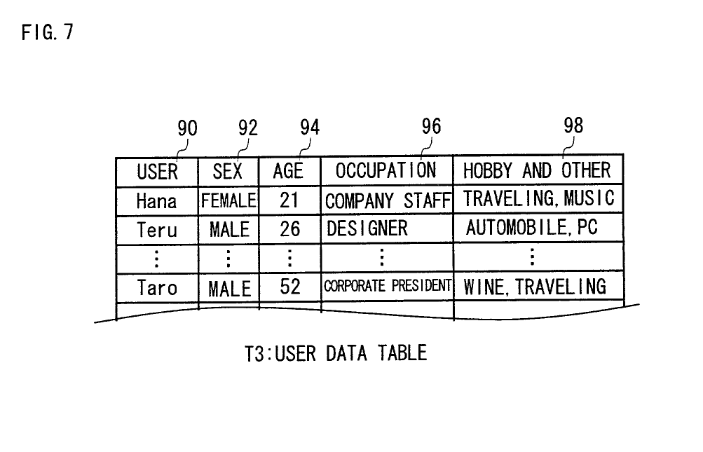

FIG. 7 shows an internal structure of the user data table T3. The user data table T3 includes a user column 90, a gender column 92, an age column 94, an occupation column 96 and a hobby column 98. For example, as individual data for a user “Taro”, described are “male” as gender, “52 years old” as age, “corporate president” as occupation, and “wine and traveling” as hobby, etc. These data are utilized when recommending candidates for merchandise.

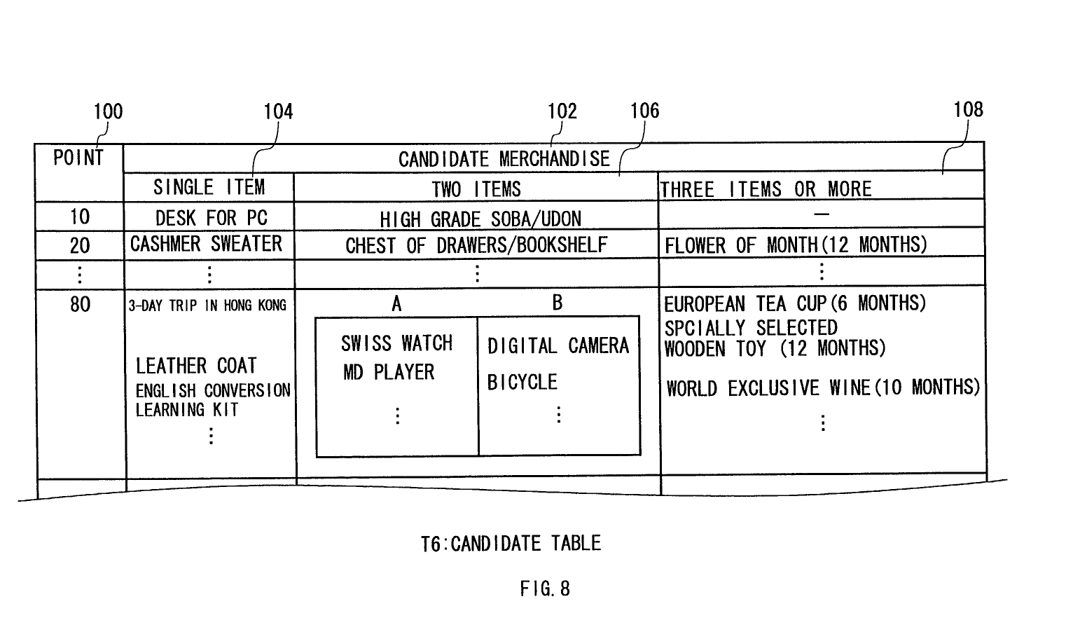

FIG. 8 shows an internal structure of the candidate table T6. The candidate table T6 includes a point column 100 and a candidate merchandise column 102. The candidate merchandise column 102 includes a single item column 104, a two item column 106 and three or more item column 108. The point column 100 indicates shortage points, and the candidate merchandise column 102 indicates a candidate of merchandise by which to cover the shortage points. For example, for a user who wishes to acquire additional 10 points, “a desk for PC” is a candidate by which the 10 points will be covered. If the user wishes to cover the shortage points by two items, “high grade Soba/Udon” are the candidates. If the shortage point is 80 and is to be covered by a single item, “3-day trip in Hong Kong”, “leather coat” and so forth are the candidates. If the user wishes to cover the shortage points by two items, he/she can select one item from A column (“Swiss watch, MD player, . . . ”) in the two item column 106 and another item from B column (“digital camera, bicycle, . . . ”) If the user wishes to cover the shortage points by three or more items, he/she can apply for a 6-months-6-times series of “European tea cup” or a 12-months-12-times series of “specially selected wooden toys”.

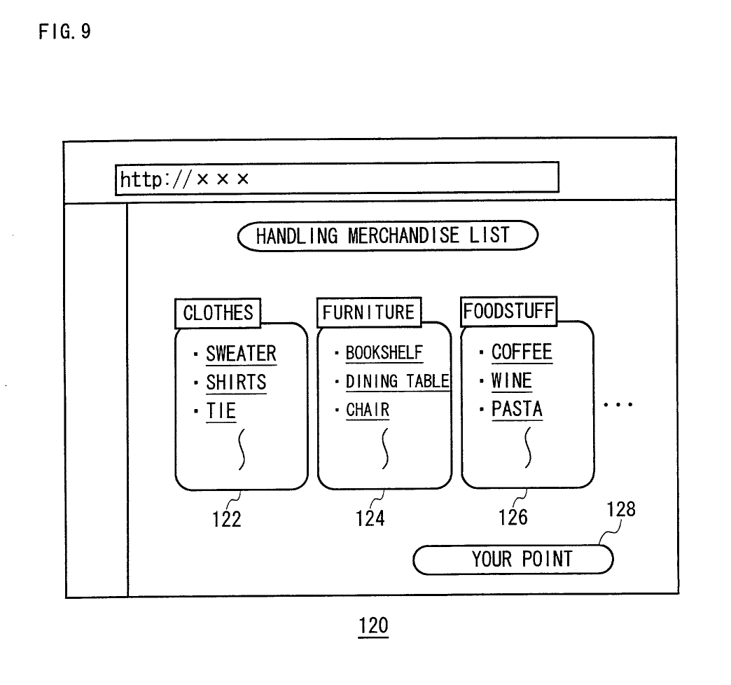

FIG. 9 is an example of a screen 120 displayed on the user terminal 12 when the user accesses an on-line shopping page in the purchase point managing site 16. Here, a “handling merchandise list” is displayed where categories of clothes 122, furniture 124, foodstuff 126 and others are shown. Each category is broken into parts according to merchandise levels. For example, items such as “sweater” and “shirts” are listed in the category of the clothes. The user accesses a page showing the merchandise list by selecting an item of his/her choice. A “your point” button 128 is provided in the right-below position of the screen 120.

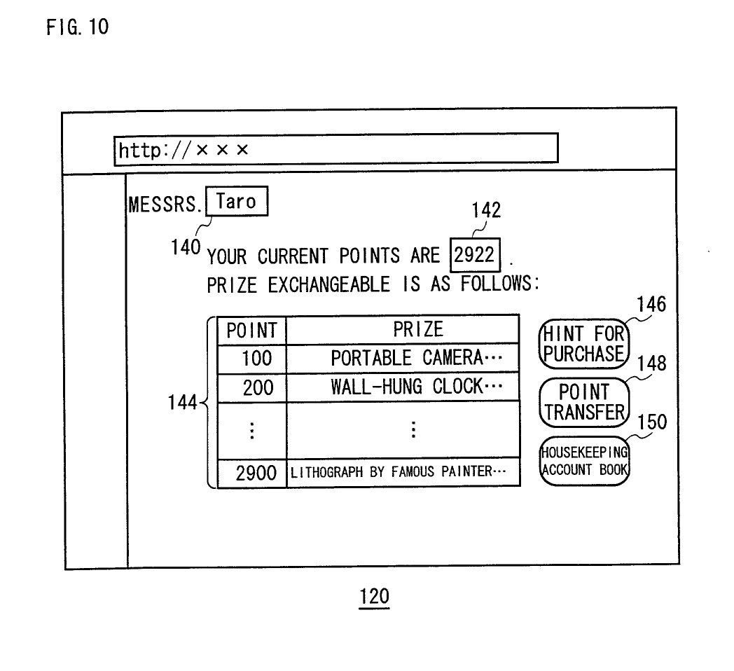

FIG. 10 is a screen 120 displayed on the user terminal 12 when the user clicks on the “your point” button 128. “Taro” is displayed in a user name column 140, and “2922” is displayed on a point-earned-so-far column 142. Prizes which can be exchanged for the value of the earned points or less are displayed in the order where each prize differs from another by 100 points in a prize column 144. The prize column 144 is generated from the exchange table T5. In the right side of the screen 120, displayed are a “hint for purchase” button 146, a “point transfer” button 148 and a “housekeeping account book” button 150.

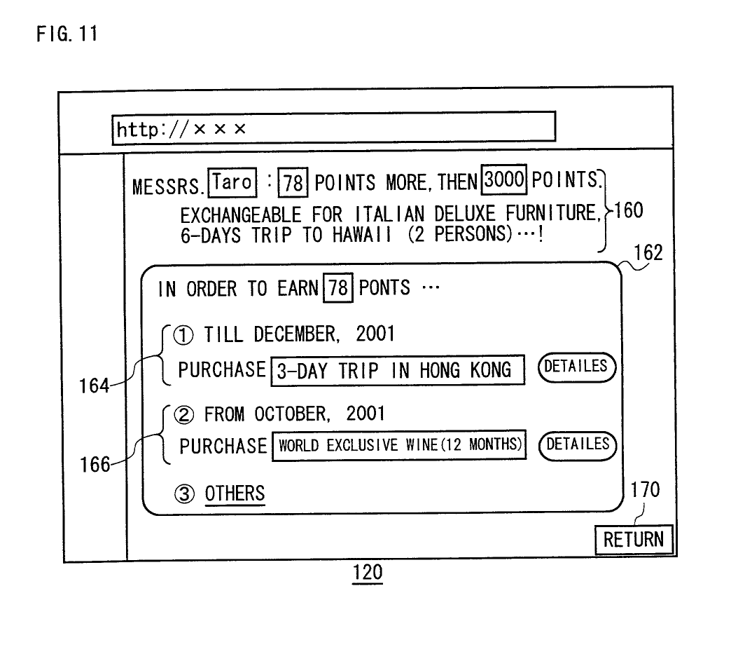

FIG. 11 is a screen 120 displayed on the user terminal 12 when the user “Taro” clicks on the “hint for purchase” button 146. Displayed in a status explanation column 160 is a statement indicating that Italian deluxe furniture or other prize can be obtained if the user saves additional 78 points to reach 3000 points.

In a merchandise recommending column 162, there is displayed a candidate of the merchandise which is recommended to purchase in order to acquire 78 points. The merchandise recommending unit 36 selected these candidates from the candidate table T6 by referring to the hobby of the user “Taro” (“wine, traveling”), and “3-day trip in Hong Kong” (whose last effective date of purchase is December, 2001) is listed in a first recommendation column 164. The term of validity for the earned points and a time limit of merchandise planning are taken into consideration. In a second recommendation column 166, “world exclusive wine (12 months)” is listed and its starting date (October, 2000) is specified. In each of the first and second recommendation buttons 164 and 166, respective “details” buttons are provided, which will facilitate user's decision making. In the right-below of the screen 120, a “return” button 170 is provided so that a user can return to a state shown in FIG. 10 by clicking on this “return” button 170.

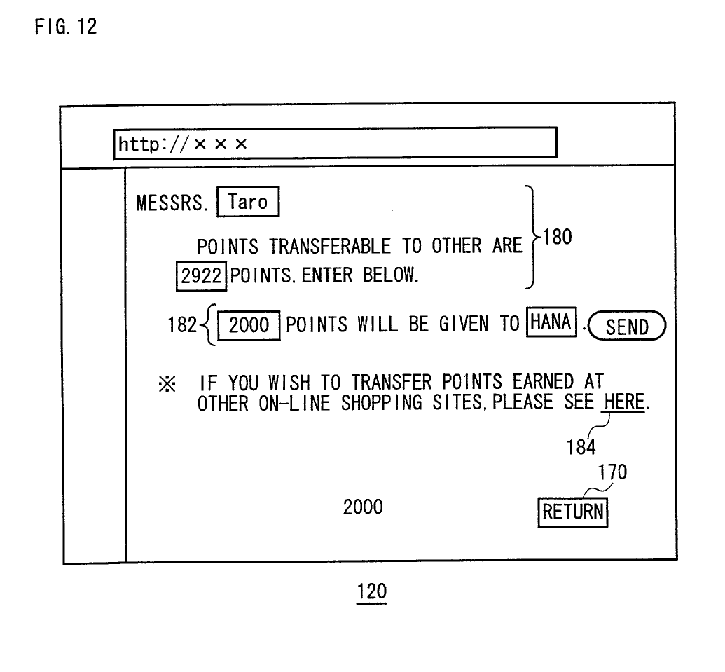

FIG. 12 is a screen 120 displayed on the user terminal 12 when the user clicks on the “point transfer” button 148 on the screen 120 shown in FIG. 10. Here, “2922” is displayed in a transferable point column 180, as points which the user “Taro” can transfer to other people. This value may be the current points or may be a predetermined upper limit value. Below the transferable point column 180, there is provided a transfer specifying column 182 where a user name, to whom the points are to be given, and its points can be inputted. Here, described is that the user “Taro” wishes to give “2000” points to the user “Hana”. When a “send” button is clicked, the point table T4 is updated to complete the transfer of the points.

The user “Taro” has saved up a relatively large amount of points. For example, instead of sending his daughter who is the user “Hana” a present for her birthday, graduation or the like, the user “Taro” can transfer the 2000 points to her so that she can buy things worth up to 100,000 yen at her discretion. Moreover, for a user who has grandchildren, for example, the user has an option to purchase the “specially selected wooden toy” and specify the grandchildren's address as the address for the “toy” to be delivered, so that a toy or other things can be delivered to grandchildren every month and can also earn points. Moreover, such the earned points can be transferred to the grandchildren or their parents. This servicing scheme is suitable for those users of old age who have sufficient time and money but would not go out to buy and send presents or the like.

Below the transfer specifying column 182, there is provided a region where, instead of transferring the points to others, the points the user himself/herself has earned are added to points earned at other on-line shops, and moreover there is provided therein a link 184 for a user wishing to have such the service.

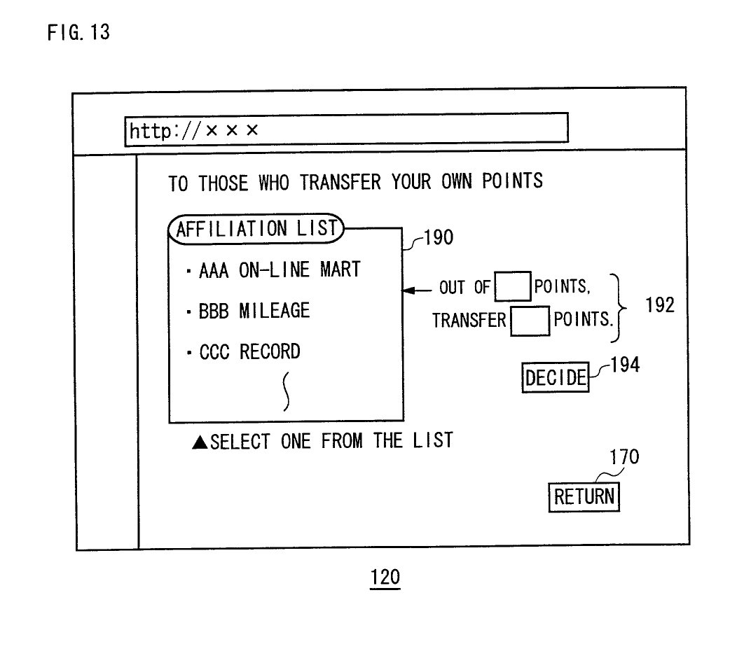

FIG. 13 is a screen 120 displayed on the user terminal 12 when the user clicks on the link 184. On this screen, “AAA online mart”, “BBB mileage” and so forth are displayed as contents of a transferable affiliation list 190, and the user can select a desirable point managing system from those listed. After selecting one from the transferable affiliation list 190, the user fills out a transfer point column 192 in the right side of the screen 120. In the case of this user, up to 2922 points are transferable, so that an arbitrary value equal to or less than 2922 points can be entered. After entering the value, the point table T4 is updated by clicking on a “decide” button 194, and the transfer of the points is completed. Moreover, conditions as to an exchange rate of the points transferable between a user and his/her affiliated online shops and whether or not the transfer shall be permitted in an interactive manner, and other conditions may be determined between both parties as a separate issue. However, it will not be difficult to incorporate such the conditions into the system.

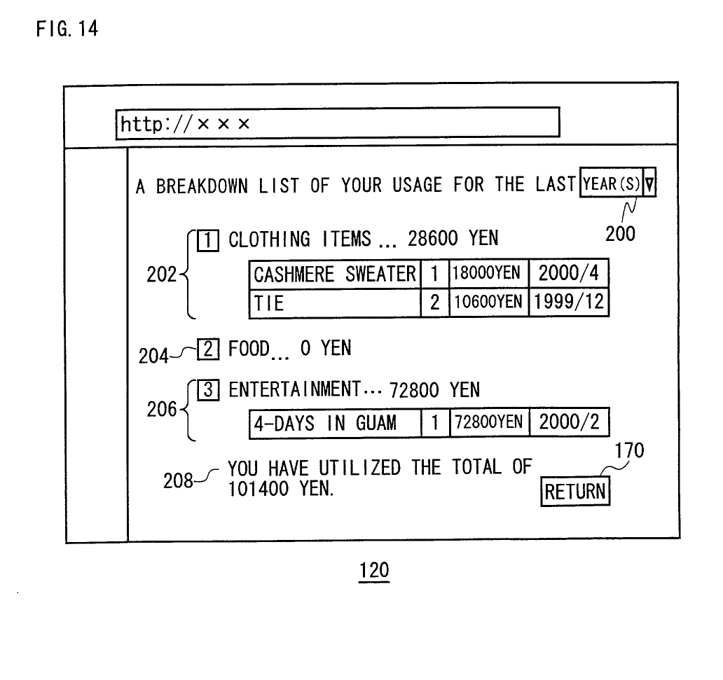

FIG. 14 is a screen 120 displayed on the user terminal 12 when the user clicks on the housekeeping account book button 150 shown in FIG. 10. There is provided a period column 200 for specifying how past it goes back into the history. In the case of a pull-down menu mode, for example, “this month only”, “for the last three months”, “for the last half a year”, “for the last one year” or the like may be specified. In FIG. 14, for example, “1 year” (for the last one year) is displayed while a usage content of the user is classified and displayed by a clothing items column 202, a food column 204, an entertainment column 206 and so forth. For example, a total usage amount of “28600 yen”, the purchased merchandise consisting of a “cashmere sweater” item, two “tie” items, and the subtotal amount thereof and the purchase period are recorded in the clothing items column 202. Similar detailed contents of items other than clothing items are also recorded, and “101400 yen” is recorded in a total amount column 208 in the end. Thus, the user can utilize this screen 120 as an online housekeeping account book.

The present invention has been described based on the embodiments which are only exemplary. It is understood by those skilled in the art that there exist other various modifications to each component and the combination of each processing described and that such modifications are encompassed by the scope of the present invention. Such the modifications include the following.

Though the relationship between the earned points and the prizes are indicated in FIG. 10, it is desirable that various valuation modes be also indicated such as a case where the earned points are used for a single prize or two or more prizes in combination. Such a function can be incorporated into the prize presenting unit 40, and the prize presenting unit 40 may suggest the combination of the prizes before the prize presenting unit 40 specifies a prize for which the user wishes to exchange his/her earned points. When so doing, the prize presenting unit 40 may suggest the combination according to the individual data of the user.

Though in FIG. 2 a function relating to the purchase of merchandise, such as the merchandise display unit 34 and the merchandise receiving unit 32, is incorporated into the purchase point managing apparatus 24, such functions need not be implemented in the purchase point managing apparatus 24 and the purchase point managing apparatus 24 may specialize only on management of the points. In that case, sharing the purchase point managing apparatus 24 among a plurality of point managing systems will be easily realized, so that the mutual transfer between the points and the mutual utilization thereof are realized smoothly.

According to the present embodiments, the user's points earned by the purchase of merchandise can be further effectively utilized, which also contributes to promoting the purchase of merchandise.

Although the present invention has been described by way of exemplary embodiments, it should be understood that many changes and substitutions may be made by those skilled in the art without departing from the spirit and the scope of the present invention which is defined by the appended claims.

What is claimed is:

1. A purchase point managing apparatus, comprising:
a point table which records per user a total value of points which a user earns by purchasing merchandise;
a merchandise table which describes relationship between the merchandise and a point earned as a result of purchase thereof;
an exchange table which describes relationship between the point and a prize offered to the user according to the point earned; and
a merchandise recommending unit which presents to the user a merchandise candidate to be purchased so as to acquire a predetermined prize.

2. A purchase point managing apparatus as recited in claim 1, further comprising a candidate table which stores data on the merchandise candidate,
wherein said candidate table stores, in addition to said data, data on a plurality of merchandise in combination which are suggested to be purchased to acquire the predetermined prize.

3. A purchase point managing apparatus as recited in claim 2, wherein said merchandise recommending unit combines the merchandise to be purchased and a purchasing timing thereof by referring to said merchandise table so as to define a purchasing model, and presents the purchasing model to the user.

4. A purchase point managing apparatus as recited in claim 3, further comprising a user data table which stores individual data on the user,
wherein said merchandise recommending unit presents to the user a purchasing model suitable for the user by extracting the purchasing model from said candidate table based on the individual data.

5. A purchase point managing apparatus as recited in claim 1, further comprising a first point transfer unit which transfers points in whole or in part earned by the user to another user.

6. A purchase point managing apparatus as recited in claim 2, further comprising a first point transfer unit which transfers points in whole or in part earned by the user to another user.

7. A purchase point managing apparatus as recited in claim 3, further comprising a first point transfer unit which transfers points in whole or in part earned by the user to another user.

8. A purchase point managing apparatus as recited in claim 4, further comprising a first point transfer unit which transfers points in whole or in part earned by the user to another user.

9. A purchase point managing apparatus as recited in claim 1, further comprising a second point transfer unit which transfers points earned by a single user between points earned under other point managing system and those earned in said purchase point managing apparatus.

10. A purchase point managing apparatus as recited in claim 2, further comprising a second point transfer unit which transfers points earned by a single user between points earned under other point managing system and those earned in said purchase point managing apparatus.

11. A purchase point managing apparatus as recited in claim 3, further comprising a second point transfer unit which transfers points earned by a single user between points earned under other point managing system and those earned in said purchase point managing apparatus.

12. A purchase point managing apparatus as recited in claim 4, further comprising a second point transfer unit which transfers points earned by a single user between points earned under other point managing system and those earned in said purchase point managing apparatus.

13. A purchase point managing apparatus as recited in claim 1, wherein said point table is updated whenever a point is transferred to or from other point managing system.

14. A purchase point managing apparatus as recited in claim 9, wherein said second point transfer unit presents, in a user selectable manner, to the user other point managing system to and from which a point is transferable.

15. A purchase point managing apparatus as recited in claim 1, further comprising a history notifying unit which manages a purchase history of the user in the past and classifies merchandise purchased by the user based on a predetermined criterion so as to be notified to the user.

16. A purchase point managing apparatus as recited in claim 1, further comprising a prize presenting unit which presents the prize exchanged for the points, via on-line or off-line,
wherein said prize presenting unit indicates in advance a single prize or a plurality of prizes in combination exchangeable for the points.

17. A purchase point managing apparatus as recited in claim 1, wherein the apparatus is provided either in a world wide web (WWW) server or external thereto independently.

18. A method of managing a purchase point, comprising:
recording per user a total value of points which a user earns by purchasing merchandise;
selecting a merchandise candidate which is recommended to purchased in order to acquire a predetermined prize, by comparing relationship between the merchandise, a point earned as a result of purchase of the merchandise and a prize offered to the user according to the point earned, to the total value of points; and
presenting the merchandise candidate selected to the user.
